(19) United States
(12) Patent Application Publication
(10) Pub. No.: US 2005/0216786 A1
(43) Pub. Date: Sep. 29, 2005

(54) Data accumulation system

(75) Inventors: Yoshiyasu Nakashima, Kawasaki (JP); Akinobu Ueda, Kawasaki (JP); Shigehiro Idani, Kawasaki (JP); Goro Watanabe, Kawasaki (JP); Akira Shiba, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/072,470

(22) Filed: Mar. 7, 2005

Related U.S. Application Data
(62) Division of application No. 09/816,540, filed on Mar. 26, 2001.

(30) Foreign Application Priority Data
Jul. 4, 2000 (JP) 2000-201809

(51) Int. Cl. G06F 11/00

(52) U.S. Cl. 714/4

(57) ABSTRACT

The present invention provides a data accumulation system wherein data storage process is simplified by using a portable communication device such as a notebook type PC as a data storage device. The data accumulation system of the invention comprises a pen scanner 21 as a data output device, a notebook type PC 22 as a data storage device and a portable terminal 23 as a data checking terminal. The pen scanner 21 reads a character string or the like in a document as an image and sends data of the image to the note PC 22. The note PC 22 generates thumbnail image data of the image data and sends the data to the portable terminal 23. When the thumbnail image is displayed on a display of the portable terminal 23, a user watches it and checks whether or not the data are worth storing. If the user decides to store the data, the user input a storage command from the portable terminal 23 to the note PC.

### CROSS-REFERENCE TO RELATED APPLICATION

This application is a divisional of U.S. application Ser. No. 09/816,540, filed Mar. 26, 2001 and claims priority to Japanese Application No. 2000-201809, and incorporated by reference herein.

### BACKGROUND OF THE INVENTION

1. Field of the Invention

The present invention relates to a data accumulation system that serves to record and accumulate data to a communication device such as portable computer at the demand of a user of the communication device.

2. Description of the Prior Art

Recently, data communication between personal computers or between a personal computer (PC) and another communication device has been studied and utilized. A close wireless link protocol called Bluetooth was established in 1998 and, accordingly, a wireless communication interface is to be used for a notebook type PC, a portable phone, a portable terminal (or PDA) and like portable communication devices. It is expected that such wireless communication interface will facilitate data communication of a notebook type PC and like devices and will find various bland-new applications.

For example, many business people use notebook type PCs to store data in a memory device thereof when collecting data outside the user's office, e.g., during business trips. In such cases, if the wireless communication mentioned above is utilized, it will be possible to store data transmitted from a data output device by means of the wireless communication in the memory device of the notebook type PC with the notebook type PC being kept in the user's bag.

In actuality, however, it is necessary for a user to take a notebook type PC out of the bag to communicate with a communication device that transmits data by means of a predetermined communication cable and to check on the display whether or not the data are worth storing and store the data in the memory device if the data are useful. Even when the wireless communication via the Bluetooth protocol is realized, the user still has to take the notebook type PC out of the bag if the received data cannot be checked other than on the display of the PC.

Further, due to restrictions such as miniaturizing, lightening, low pricing, etc., it is difficult to provide a portable telephone or a portable terminal with an integrated memory device having a sufficiently large memory capacity. To overcome the difficulty, considered is such a mode of application wherein history data of an operation and information obtained by the operation are temporarily stored in a memory device of a portable phone or a portable terminal and then transferred to a notebook type PC so as to be stored in an integrated memory device of the PC. Above mode of application will make it possible to store a large amount of past history data. Therefore, when data once obtained from an information source is required, the data can be taken out of the integrated memory device of the PC without communicating with the information source again.

In the mode of application, however, it is necessary to transfer data memorized in the portable phone or the portable terminal to the notebook type PC before the memory capacity becomes full and the data memorized are deleted. Such operation is an extra operation, and, in some cases, it may be difficult to timely perform the operation.

### SUMMARY OF THE INVENTION

An object of the present invention is to provide a data accumulation system which can store data easily and eliminate extra operations by using a portable communication device having a wireless communication portion such as a notebook type PC as a data storage device or a history recording and reproducing device.

Referring to FIG. 1, the first structure of the data accumulation system of the invention comprises a data output device 11 that outputs data required by a user and a data storage device 12 having a storing portion part of the data imparted from the data output device and a data checking terminal 13, which is a portable terminal for wireless communication with the data storage device, having a display which displays data imparted from the data output device to the data storage device so that a user can check whether or not the data are worth storing.

According to the first structure, it is possible to transfer data, which have been provided by the data output device to the data storage device, to the data checking terminal such as a PDA by means of a wireless communication so that the data can be checked whether or not the data are worth storing as being displayed on a display of the data checking terminal with keeping the data storage device such as a notebook type PC inside a bag.

Preferably, the data checking terminal may automatically perform filtering of the data to be stored.

Further, the data checking terminal may preferably take out the data to be stored out of all the transferred data or process the data to be stored and then send back the data to be stored to the data storage device.

For example, in the case where the data provided by the data output device to the data storage device are image data, the data checking terminal may preferably generate a thumbnail image of the image data to display the thumbnail image on the display.

Example of the data output device includes a POS terminal used in an eating and drinking space or a shop, an ATM used in a financial establishment, etc. In this case, data imparted from the output device to the data storage device contain, for example, items relating to transaction.

The example further includes an output device for explaining exhibits or merchandizes, which is equipped at a plurality of locations in a museum or a department store.

Further, an information transmission device installed in a public space or inside a carriage can be used as the data output device.

The second structure of the data accumulation system of the present invention comprises a history target device having a wireless communication portion and a history recording and reproducing device having a wireless communication portion, wherein the history target device is provided with a data reading portion which obtains history data of operation and information obtained as a result of the operation and transmit the history data obtained by the data reading portion to the history recording and reproducing device via the wireless communication portion, and the history recording and reproducing device records the history data transmitted from the history target device synchronously.

According to the second structure, history data of an operation of a portable device having a small memory capacity such as a potable phone or a portable terminal and information obtained by the operation are stored in the memory device of the portable device at the same time with the history data being read by the data reading portion and transmitted to the history recording and reproducing device via the wireless communication portion. Then, the history data are accumulated in a memory device of the history recording and reproducing device (e.g. notebook type PC) that has a sufficiently large memory capacity.

In this way, backup data of history data of a portable device such as a portable phone or a portable terminal can easily be obtained from the history recording and reproducing device without an extra operation. Further, in the case of obtaining information once obtained from the Internet using a portable device, the target information can be taken out of information accumulated in the history recording and reproducing device without communicating with the Internet again since a large amount of information can be stored in the history recording and reproducing device. Moreover, it is possible to reduce the Internet connection charge by downloading information such as a homepage to the history recording and reproducing device and then reproduce the information after cutting connection with the Internet to examine the information.

Preferably, each of a plurality of the history target devices may have a specific identifier so that the history recording and reproducing device can authenticate each of the history target devices. Such identifiers enable the history recording and reproducing device to process data sent by proper history target devices only. Further, a batch management of information obtained by the plurality of history target devices using the identifiers enables summary and integration of data.

The history target device may preferably have an authentication portion for specifying a user, and the history recording and reproducing device may preferably record data sent from the history target device for each user. Such authentication portion makes it possible to select and record data for each user in the case where a plurality of users shares one history target device.

It is also preferred that the history recording and reproducing device reads data recorded therein and sends the data back to the history target device so that the history target device redisplay the data received thereby. Thus, the data recorded in the history recording and reproducing device can be reviewed on a display of the history target device without directly operating the history recording and reproducing device.

The history target device may preferably control start and stop of recordation of history data in the history recording and reproducing device.

The history target device may preferably switch display/non-display of history data of an operation and information obtained by the operation and, when the non-display is chosen, record the whole history data without displaying each of the history data. Thus, the time for recording data can be reduced.

The history recording and reproducing device may preferably store history management information together with history data and send the history management information to the history target device, so that the history target device can transfer only a portion of data different from that of the previous transmission to the history recording and reproducing device. Thus, recording of overlapping data can be avoided.

It is preferred that information acquisition steps in the history target device are recorded in the history recording and reproducing device, so that the history target device obtains data to be recorded according to the information acquisition steps transmitted from the history recording and reproducing device and transmits the obtained data successively to the history recording and reproducing device. Thus, a stylized operation such as downloading can be automated.

The history recording and reproducing device may preferably record information containing a definition of a data processing method so that the history data are processed according to the information before being stored therein. For example, the history data may be summarized as required by a user or converted to such data that facilitates the user's understanding of aptitude of the history data.

### BRIEF DESCRIPTION OF THE DRAWING

FIG. 1 is a block diagram showing the first structure of the data accumulation system of the present invention.

FIG. 2 is a block diagram showing the first embodiment according to the first structure of the data accumulation system of the invention.

FIG. 3 is a block diagram showing the second embodiment according to the first structure of the data accumulation system of the invention.

FIG. 4 is a block diagram showing the third embodiment according to the first structure of the data accumulation system of the invention.

FIG. 5 is a block diagram showing the fourth embodiment according to the second structure of the data accumulation system of the invention.

FIG. 6 is a block diagram showing the fifth embodiment according to the second structure of the data accumulation system of the invention.

FIG. 7 is a block diagram showing the sixth embodiment according to the second structure of the data accumulation system of the invention.

FIG. 8 is a block diagram showing the seventh embodiment according to the second structure of the data accumulation system of the invention.

FIG. 9 is a block diagram showing the eighth embodiment according to the second structure of the data accumulation system of the invention.

FIG. 10 is a block diagram showing the ninth embodiment according to the second structure of the data accumulation system of the invention.

FIG. 11 is a block diagram showing the tenth embodiment according to the second structure of the data accumulation system of the invention.

FIG. 12 is a block diagram showing the eleventh embodiment according to the second structure of the data accumulation system of the invention.

FIG. 13 is a block diagram showing the twelfth embodiment according to the second structure of the data accumulation system of the invention.

FIG. 14 is a block diagram showing an example of a structure of the history target device and the history recording and reproducing device according to the second structure of the data accumulation system of the invention.

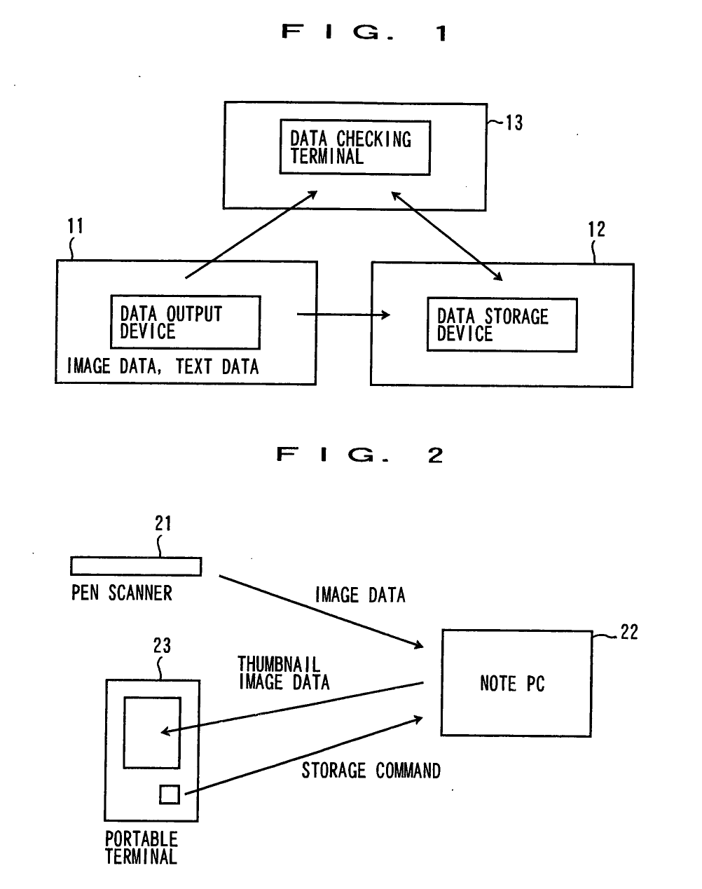

### DESCRIPTION OF THE PREFERRED EMBODIMENTS

Embodiments of the present invention will hereafter be explained with reference to the attached drawings.

FIG. 2 is a block diagram showing the first embodiment according to the first structure of the invention. In this example, the data accumulation system includes a pen scanner 21 as a data output device, a notebook type PC (hereinafter simply referred as “note PC”) 22 as a data storage device and a so-called portable terminal (PDA) 23 as a data checking terminal.

The pen scanner 21 is a small image scanner for reading a character string, etc. in a document as an image. The image read by the pen scanner 21 is sent to the note PC 22 as image data. The note PC 22 generates thumbnail image data of the image data and sends the thumbnail image data to the portable terminal 23. When the thumbnail image is displayed on a display of the portable terminal 23, a user watches the image and check whether or not the data are worth storing. If the user decides to store the data, the user input a storage command using the portable terminal 23 so that the command is transferred to the note PC 22.

Thus, reading of a character string, etc. in a document using the pen scanner 21 and recording of the read data can be performed with checking each operation and as the note PC 22, for example, being kept in a bag, etc.

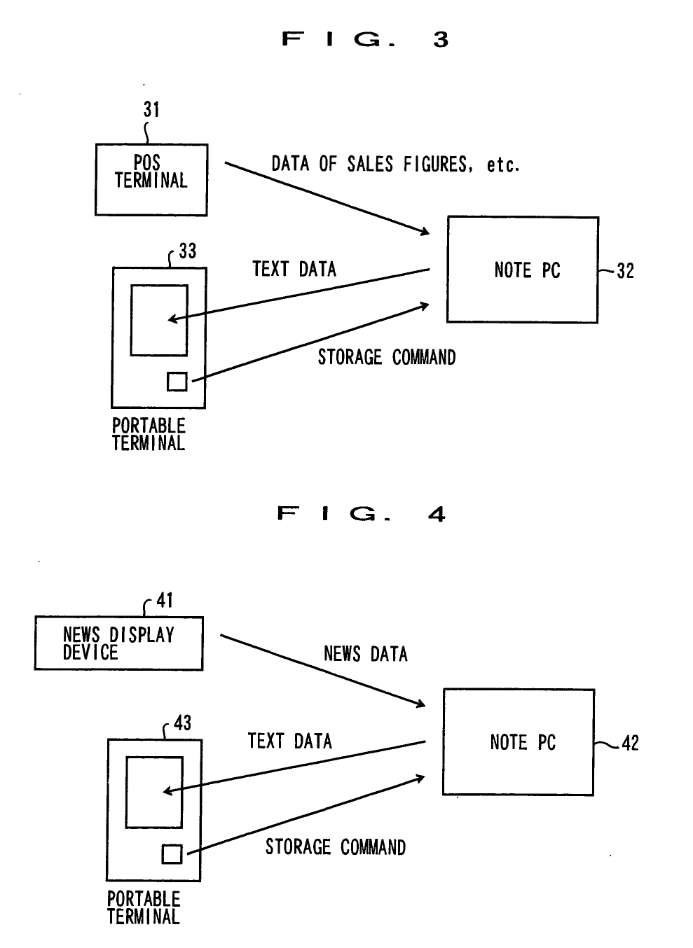

FIG. 3 is a block diagram showing the second embodiment of the present invention. In this example, the data accumulation system includes a POS terminal 31 as a data output device installed for accounting, etc. of a shop, a note PC 32 as a data storage device and a portable terminal 33 as a data checking terminal.

The POS terminal 31 transmits data of sales figures, etc. via a close wireless communication to the note PC 32. The note PC 32 converts data received thereby into text data and send the text data to the portable terminal 33. A user watches the text data displayed on the portable terminal 33 and checks whether or not the data are worth storing. If the user decides to store the data, the user input a storage command from the portable terminal 33 so that the command is transferred to the note PC 32.

Thus, the user can store only the necessary information in the note PC 32 with checking the data sent from the POS terminal 31 by using the portable terminal 33 as the note PC 32, for example, being kept in a bag, etc. As a modification, an ATM seen in a bank, etc. can be used in place of the POS terminal as the data output device 31.

FIG. 4 is a block diagram showing the third embodiment f the present invention. In this example, the data accumulation system includes a news display device (electronic notice board) 41 installed in a train, a waiting room and so on as an output device, a note PC 42 as a data storage device and a portable terminal 43 as a data checking device.

The news display device 41 displays information such as news, advertisements, etc. and transmits the same via a close wireless communication. The note PC receives the information and converts the information into text data so as to transmit the text data to the portable terminal 43. A user watches the data displayed on the portable terminal 43 and checks whether or not the data are worth storing. If the user decides to store the data, the user input a storage command from the portable terminal 43 so that the command is transmitted to the note PC 42.

Thus, the user can store the necessary data in the note PC 42 by using the portable terminal 43 when watching information such as news displayed on a news display device.

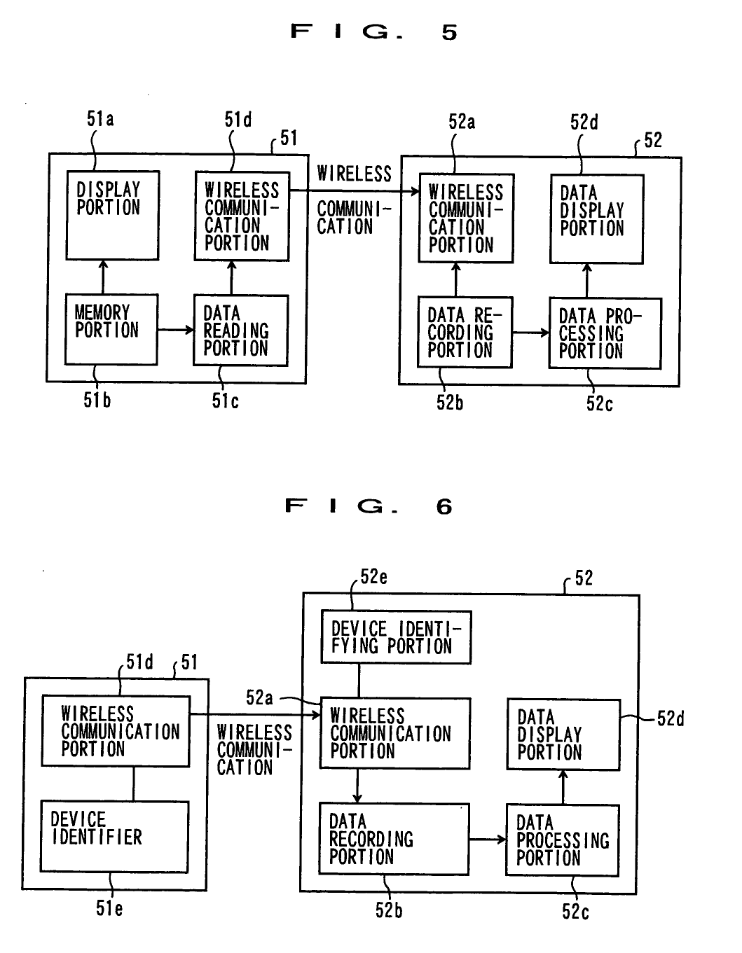

FIG. 5 is a block diagram showing the fourth embodiment according to the second structure of the present invention. A history target device 51 such as a portable phone, a portable terminal or the like is provided with a display portion 51a comprising a liquid display, a memory portion 51b comprising a semiconductor memory, a data reading portion 51c comprising a circuit having a microprocessor, etc. and a wireless communication portion 51d. A history recording and reproducing device 52 such as a note PC is provided with a wireless communication portion 52a, a data recording portion 52b such as a disk memory device, a data processing portion 52c having a microprocessor and data a display portion 52d.

History data which contains data downloaded from the Internet using the history target device and operation data for the downloading, for example, are stored temporarily in the memory portion 51b having a relatively small memory capacity at the same time with being displayed on the display portion 51a. The data reading portion 51c reads data out of the memory portion 51b and send the data to the wireless communication portion 51a. The wireless communication portion 52a performs wireless communication with the wireless communication portion 52a of the history recording and reproducing device 52 to transmit the data sent from the data reading portion 51c.

In the history recording and reproducing device 52, data received by the wireless communication portion 52a are recorded in the recording portion 52b. The data processing portion 52c reads data stored in the data recording portion 52b and processes the data to display them on the data display portion 52d.

Thus, backup data of the data received by the history target device 51 that does not have a sufficiently large memory capacity can be made by the history recording and reproducing device 52. The data recorded in the data recording portion 52b of the history recording and reproducing device 52 are converted by the data processing portion 52c into such data that are classified by type, time and day, etc., so that a user can understand the data easily, and then displayed on the display portion 52d. In the case of downloading from a network which incurs charges, it is possible to reduce the charges by using the history recording and reproducing device 52 in such a manner that downloading target data first, and then cutting the connection with the network, followed by freely browsing the target data stored in the history recording and reproducing device 52.

FIG. 6 is a block diagram showing the fifth embodiment of the present invention. In this example, in addition to the fourth embodiment shown in FIG. 5, the history target device 51 has device identifiers for specifying devices. The history recording and reproducing device 52 is provided with a device identifying portion for identifying devices.

Thus, in the case of using a plurality of history target devices, the history recording and reproducing device can record the necessary data only by screening the history target devices. Such identifiers enable a batch management of information obtained by the history target devices, thereby realizing summary and integration of distributed data.

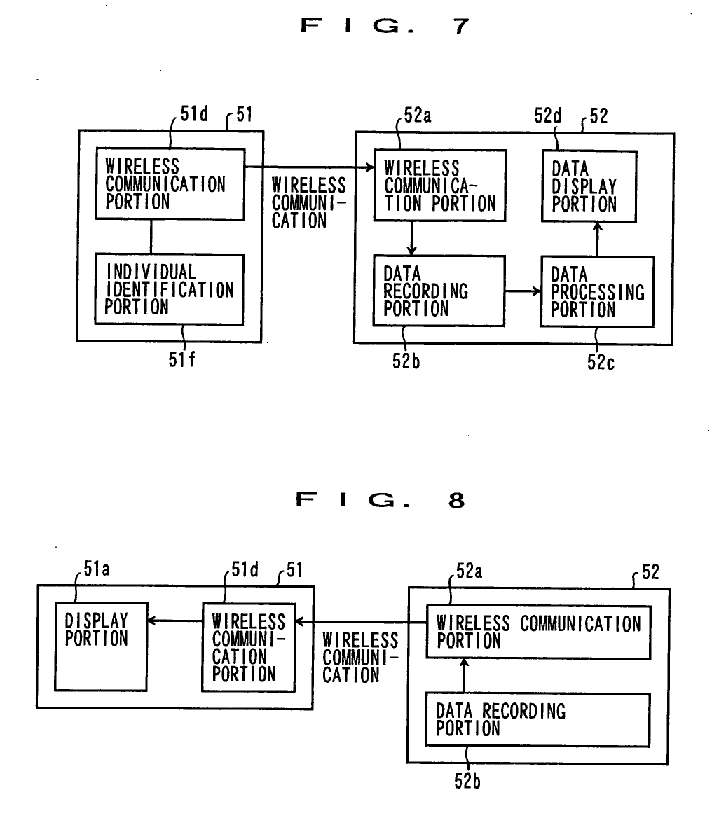

FIG. 7 is a block diagram showing the sixth embodiment of the present invention. In this embodiment, in addition to the fourth embodiment shown in the FIG. 5, the history target device 51 is provided with an individual identification portion for specifying a user. For the identification of a user, an ID number that specifies each user, for example, is used.

Thus, it is possible to select and record data for each user even in the case where the single history target device 51 is shared by a plurality of users. The history recording and reproducing device 52 records data for each user based on data transmitted from the history target devices and the user information (ID numbers).

FIG. 8 is a block diagram showing the seventh embodiment of the present invention. In this example, the history recording and reproducing device 52 reads data recorded in the data recording portion 52b as backup data and transmits the data to the history target device 51 via the wireless communication portion 52a. The history target device 51 displays the backup data received at the wireless communication portion 51d on the display portion 51a. Thus, it is possible to redisplay the data recorded at the data recording portion 52b in the history recording and reproducing device 52 on the history target device 51.

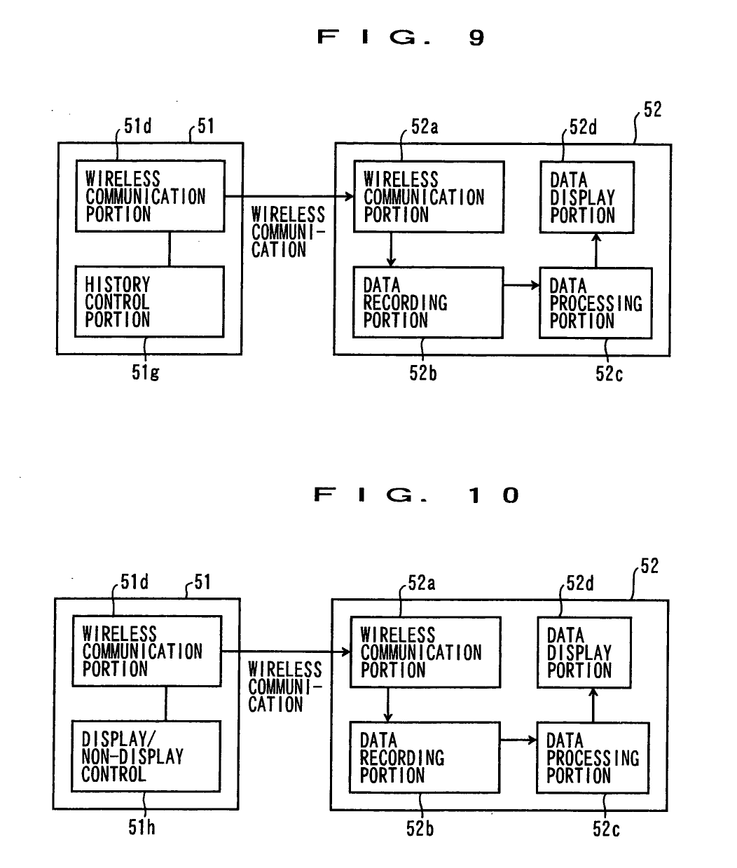

FIG. 9 is a block diagram showing the eighth embodiment of the present invention. In this embodiment, in addition to the fourth embodiment shown in FIG. 5, the history target device 51 is provided with a history control portion 51g. The history control portion 51g serves to control start and stop of recording history data of the history recording and reproducing device 52. Information of start and stop of recording set at the history control portion 51g is transmitted to the history recording and reproducing device 52 via the wireless communication portion 51d. The history recording and reproducing device 52 starts and stops recording according to the information received at the wireless communication portion 52a.

FIG. 10 is a block diagram showing the ninth embodiment f the present invention. In this embodiment, in addition to the fourth embodiment shown in FIG. 5, the history target device 51 is provided with a display/non-display control portion 51h. When “display” is selected by the display/non-display control portion 51h, data are displayed in an ordinary manner. When “non-display” is selected by the display/non-display portion 51h, obtained information (history data) is not displayed one by one, but the history data as a whole are sent to the history recording and reproducing device 52 to be recorded therein. Thus, the time required for recording can be shortened.

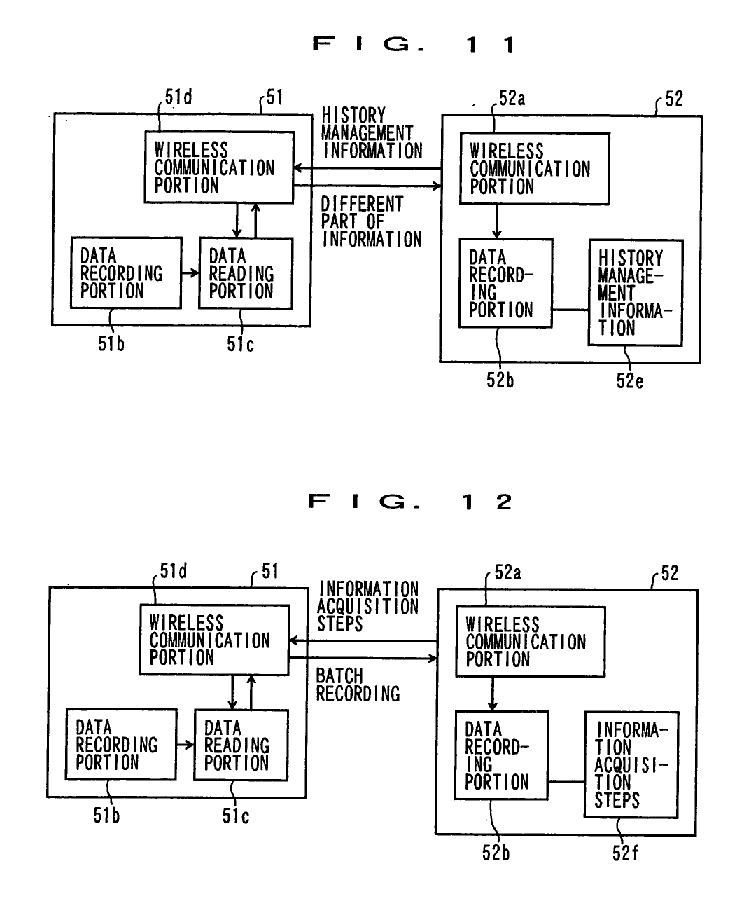

FIG. 11 is a block diagram showing the tenth embodiment of the present invention. In this embodiment, in addition to the fourth embodiment shown in FIG. 5, the history recording and reproducing device 52 stores history management information 52e at the same time with storing history data. The history management information 52e is transmitted to the history target device 51 via the wireless communication portion 52a. The history target device 51 transfers only a portion of data different from history data received thereat previously to the history recording and reproducing device 52 based on the history management information received by the wireless communication portion 51d. In this way, only the different portion of data is recorded, thereby avoiding recording of overlapping data.

FIG. 12 is a block diagram showing the eleventh embodiment of the present invention. In this embodiment, in addition to the fourth embodiment shown in FIG. 5, the history recording and reproducing device 52 memorizes information acquisition steps 52f performed in the history target device 51. The information acquisition steps 52f are transmitted to the history target device 51 via the wireless communication portion 52a. The history target device 51 obtains information according to the information acquisition steps received at the wireless communication portion 51d and memorizes the information at the memory portion 51b at the same time with transmitting the information to the history recording and reproducing device 52 via the data reading portion 51c and the wireless communication portion 51d, so that the information is recorded at the data recording portion 52b in the history recording and reproducing device 52. Thus, a stylized operation for obtaining and recording information such as downloading can be automatically performed.

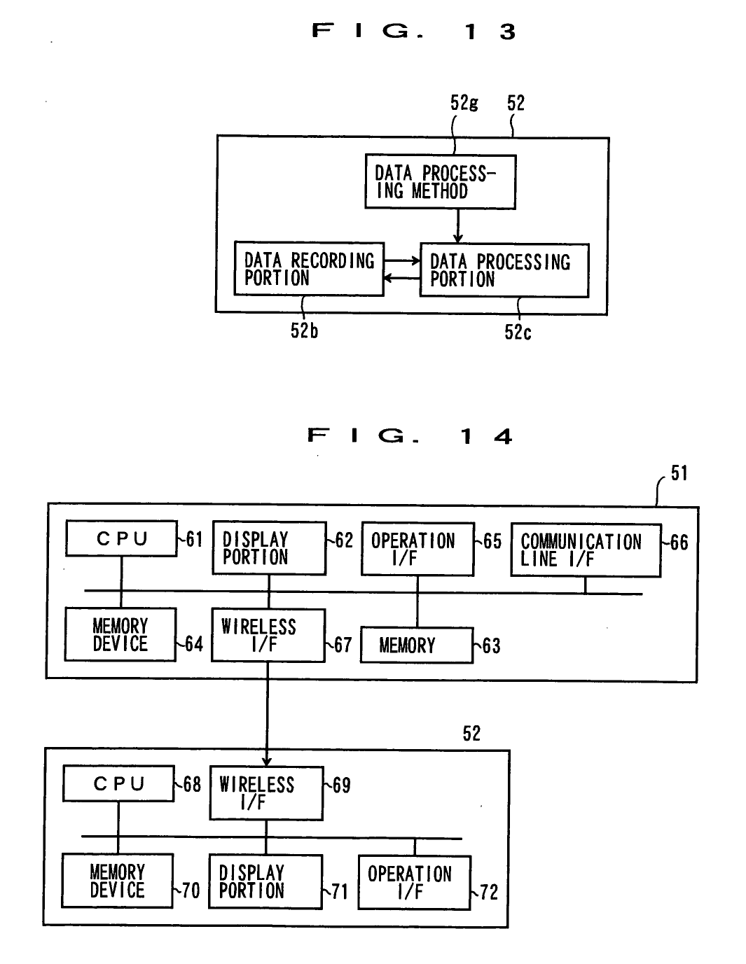

FIG. 13 is a block diagram showing the twelfth embodiment of the present invention. In this embodiment, in addition to the fourth embodiment shown in FIG. 5, the history recording and reproducing device 52 memorizes information 52g for definition of data processing method. The data processing portion 52c processes history data memorized at the date recording portion 52b according to the information 52g for the definition of data processing method, so that the processed data are recorded at the data recording portion 52b. Thus, it is possible to record history data after being summarized in accordance with the user's request or being so converted that aptitude of the history data is easily understood.

Referring to FIG. 14, examples of modifications of the history target device 51 and the history recording and reproducing device 52 of the fourth to twelfth embodiments are explained in the following.

In FIG. 14, the history target device 51 is an information processor comprising a processor device (CPU) 61 for performing process in accordance with a predetermined program, a display 62 for displaying obtained data, memory 63 for memorizing data, a memory device 64 for recording a small amount of data, an operation interface 65 for operating the whole device and the like. The history target device, e.g., a portable phone, a PDA, or the like is generally provided with a communication line interface 66 for communicating with a public line. A wireless interface 67 is also comprised in the history target device 51 used in the system of the present invention.

A user of the history target device 51 operates the device via the operation interface 65 to search and display data stored in the memory device 64 on the display 62. The user communicates with a network that utilizes a public line via the communication line interface 66 to download data from a host computer. The CPU 61 (reading portion) reads data that has been selected from memory information in the memory 63 and displayed on the display 62 and then transmits the read data to the history recording and reproducing device 52 via the wireless interface 67.

The history recording and reproducing device 52 is, like the history target device 51, an information processor comprising a CPU 68, a wireless interface 69, a memory device 70, a display 71, an operation interface 72 and the like. The memory device 70 has a relatively large memory capacity and employs a disk memory medium, etc.

The history recording and reproducing device 52 receives data via the wireless interface 69 and records the data in the order of receipt. The recording is associated with information that accompanies the data. Types of the information accompanying data are previously assigned. Examples of the information to be associated include time of recording, operation of the history target device 51, a communication line and the like. Thus, the history data and the accompanying data are recorded synchronously in the history recording and reproducing device 52 during the history target device's operation.

It is possible for a user to take out information from the history recording and reproducing device 52 and redisplay the information on the display 71 after the operation of the history target device 51. The CPU 68 performs data processing using the accompanying data and the processed data are displayed on the display 71. The CPU 68 performs the data processing by, for example, sorting history data in the order of time. Also, the CPU 68 performs the data processing by counting respectively number of line communication accesses; number of receipts of document data or number of audio dialogs using counting of event list and operation information in a certain period.

Thus, the data recorded in the history target device 51 can be summarized so that the user can understand the data contents easily. Further, since the processed data are sent back to the recording device and recorded therein, in the case where a processing is performed once before, the processing need not be repeated for displaying result of the processing thus to save time.

In the case of recording history data of a plurality of target devices 51, an individual identifier is given for each of the history target devices 51. For example, in the case where portable phones are used, telephone numbers recorded in the memory can be used as the identifiers. In the case where PDAs or PCs are used, individual names or numbers can be recorded in the memory devices as identifiers.

The history recording and reproducing device 52 resisters the identifiers of the history target devices 51 that are objects of history data recording, and the CPU 68 authenticates the history target devices. In the case where the authentication is successful, history data are recorded together with the identifier, time of authentication and so on.

In the case where a single history target device 51 is used by a plurality of users, each user is specified (authenticated) by the user's personal ID. For example, in the history target device 51 such as a PDA, etc., the authentication of a user can be performed using the user's name and password. In the case where the history target device is an ATM, an ID card can be used for authenticating a user. Since the user information as mentioned above is recorded together with history data in the history recording and reproducing device 52, individual data recorded separately in the history target devices can be automatically recorded in the history recording and reproducing device 52 only by referring to the individual data.

Since the CPU 68 in the history recording and reproducing device 52 is adapted to read data recorded in the memory device 70 and transmit the recorded data via the wireless interface 69, the recorded data in the memory device 70 can be redisplayed on the history target device 51. For example, information obtained by using a telephone terminal as the history target device 51 via a public line can be checked at the history target device 51 immediately after cutting the connection with the public line off. In this case, the history recording and reproducing device 52 serves as an external memory device of the history target device 51.

It is possible to control start and stop of transmitting memory contents of a display area to the wireless interface 67 that is performed by CPU 61 by providing the operation interface 65 in the history target device 51 with a key (press-button) for controlling the start and stop of recording history data. Thus, recording of useless history data in the history recording and reproducing device 52 can be suppressed.

It is possible to control display/non-display of the display 62 by providing the operation interface 65 in the history target device 51 with a key (press-button) for switching display/non-display of data. When the “non-display” is chosen, a message such as “transferring history data” may be displayed. For example, in the case where a user checks a large amount of data by sectioning the data and displaying the data page by page or by scrolling the data partially on a small display of the history target device 51, the user can switch from “display” to “non-display” if the user decides to record the rest of the data in the course of checking. Thus, the time for displaying the rest of the data is saved. The rest of the data are downloaded batchwise and, when the CPU 61 detects that no data is left to be recorded, the display mode can be switched to “display”.

Recorded in the memory device 70 of the history recording and reproducing device 52 is history management information that indicates format and amount of data. The history management information enables to transmit the newest data to the history target device 51 and thus to send from the history target device 51 to the history recording and reproducing device 52 only a part of data different from the data already recorded in the history recording and reproducing device 52. For example, list data comprising columns and sections, which are output from an ATM at a bank, are data containing items such as data number, particulars, credit, payment, balance, date of transaction, etc. In this case, by transmitting to the ATM (the history target device 51) a data number newest in the history management information recorded at the memory device 70 in the history recording and reproducing device 52, the ATM selects a part of data different from that recorded in the history recording an reproducing device 52 and transmits the part to the history recording and reproducing device 52. In this way, recording of overlapping data can be avoided.

The CPU 61 monitors operation contents of the history target device and transmits a series of operation steps for obtaining data to the history recording and reproducing device 52 to be recorded at the memory device 70 thereof. An identifier is given to the series of operation steps. The history recording and reproducing device 52 reads the operation steps recorded at the memory device 70 and transmits it to the history target device 51, so that the CPU 61 automatically obtains data and transmits the data to the history recording and reproducing device 52 according to the operation steps received at the history target device 51.

Even if the operation required for obtaining and recording information is complicated, the operation can be automated after a user once follows the operation steps, which are memorized. From the second time, the information can be obtained and recorded automatically. Either of the history target device 51 or the history recording and reproducing device 52 may be provided with a key for selecting the desired operation step from the operation steps recorded at the memory deice 70, a key for starting performance of the selected operation step, a key for finishing and a key for cutting off.

While the presently preferred embodiments of the present invention have been shown and described, it will be understood that the present invention is not limited thereto and that various changes and modifications may be made by those skilled in the art without departing from the scope of the invention as set forth in the appended claims.

1. A data accumulation system comprising:
a history target device including a wireless communication portion;
a history recording and reproducing device including a wireless communication portion;
the history target device further including a data reading portion for obtaining history data of an operation and information obtained as a result of the operation, the history data being transmitted from the data reading portion to the history recording and reproducing device via the wireless communication portion; and
the history recording and reproducing device receiving the history data transmitted from the history target device and recording the history data synchronously.

2. The data accumulation system according to claim 1, wherein the data accumulation system comprises a plurality of history target devices each of which has a unique identifier so that the history recording and reproducing device can authenticate each of the history target devices.

3. The data accumulation system according to claim 1, wherein the history target device further includes an authentication portion for specifying a user, and the history recording and reproducing device records data transmitted from the history target device for each user.

4. The data accumulation system according to claim 1, wherein the history recording and reproducing device reads the recorded data for transmitting the data back to the history target device, and the history target device receives and redisplays the data.

5. The data accumulation system according to claim 1, wherein the history target device controls start and stop of recordation of history data in the history recording and reproducing device.

6. The data accumulation system according to claim 1, wherein the history target device switches display and non-display of history data of an operation and information obtained by the operation, and the whole history data are recorded without being displayed when the non-display is chosen.

7. The data accumulation system according to claim 1, wherein the history recording and reproducing device stores history management information together with history data and transmits the history management information to the history target device, and the history target device transfers only a part of data different from that of the previous transmission to the history recording and reproducing device.

8. The data accumulation system according to claim 1, wherein the history recording and reproducing device stores information acquisition steps in the history target device, and the history target device obtains data to be recorded according to the information acquisition steps transmitted from the history recording and reproducing device and transmits the obtained data successively to the history recording and reproducing device.

9. The data accumulation system according to claim 1, wherein the history recording and reproducing device stores information containing a definition of a data processing method and processes the history data according to the information before storing the data.
